(19) United States
(12) Patent Application Publication
(10) Pub. No.: US 2025/0178628 A1
(43) Pub. Date: Jun. 5, 2025

(54) VEHICLE CONTROL DEVICE

(71) Applicant: TOYOTA JIDOSHA KABUSHIKI KAISHA, Toyota-shi (JP)

(72) Inventor: Kazuki FUKAZAWA, Toyota-shi (JP)

(73) Assignee: TOYOTA JIDOSHA KABUSHIKI KAISHA, Toyota-shi (JP)

(21) Appl. No.: 18/913,222

(22) Filed: Oct. 11, 2024

(30) Foreign Application Priority Data
Dec. 5, 2023 (JP) 2023-205267

(51) Int. Cl. B60W 50/14; H04N 23/698

(52) U.S. Cl. CPC B60W 50/14; H04N 23/698; B60W 2050/143; B60W 2050/146; B60W 2420/403; B60W 2554/20; B60W 2554/4029; B60W 2554/4041; B60W 2554/802

(57) ABSTRACT

The processor of the vehicle control device 1 acquires a second distance between the own vehicle and a moving object based on the position of the image of the moving object in the vertical direction within the imaging range of the monocular camera. When the second distance is greater than the first distance between the own vehicle and a stationary object, and the difference exceeds a threshold, and when the feature quantity, which is the amount of change in the position of the moving object's image relative to the amount of change in the size of the moving object's image as it moves downward and expands within the imaging range of the monocular camera, exceeds a predetermined value, the processor increases the priority of the warning process to alert attention to the moving object.

### BACKGROUND

The present invention relates to a vehicle control device that issues an alert to the driver of an own vehicle when a predetermined condition related to the distance between the own vehicle and an object is met.

### RELATED ART

A vehicle control device has been proposed that issues an alert to the driver of an own vehicle when the distance between the own vehicle and an obstacle falls below a threshold (for example, see Patent Document 1 below). This vehicle control device (hereinafter referred to as the “conventional device”) is equipped with a monocular camera and a processor. The monocular camera, for instance, is directed toward the rear of the own vehicle. The monocular camera provides images of the rear area of the own vehicle, captured at a predetermined frame rate, to the processor. The processor calculates the distance between an object located behind the own vehicle and the own vehicle by processing multiple images (images captured at different times) acquired from the monocular camera, using a predetermined algorithm when the own vehicle is in reverse.
[Patent Document 1] JP 2013-2883 A

### SUMMARY

Generally, an object captured in the upper part of the image (IMG) acquired by the monocular camera is likely to be located relatively far from the monocular camera. On the other hand, an object captured in the lower part of the same image (IMG) is likely to be located relatively close to the monocular camera. However, there may be cases where an object captured in the upper part of the same image (IMG) is relatively close to the monocular camera and positioned higher than the monocular camera. Therefore, when the distance between the own vehicle and each object is estimated (calculated) solely based on the position of each object within the imaging range (field of view) of the monocular camera (vertical coordinates in the image), the accuracy of the estimation may be low. For example, if a scene where a pedestrian is descending stairs (or a slope) and approaching the own vehicle is captured by the monocular camera, the pedestrian is likely to appear in the upper part of the image IMG[t0] obtained at the time to when the pedestrian is positioned near the top of the stairs. As a result, despite the actual distance between the pedestrian and the own vehicle being relatively small, there is a risk that the distance between the pedestrian and the own vehicle will be mistakenly estimated as relatively large because the pedestrian appears in the upper part of the image IMG[t0].

One of the objectives of the present invention is to provide a vehicle control device that detects the distance between a moving object and the own vehicle using a monocular camera, and issues an alert when a predetermined condition related to the distance is satisfied, thereby enhancing the safety of a moving object, such as one descending stairs or a slope and approaching the own vehicle.

In order to solve the above problems, the vehicle control device (1) of the present invention comprises:
a surrounding sensor (20) that includes a distance measuring sensor (21) for acquiring the distance between an object located in a predetermined first area in the traveling direction of the own vehicle (V) and the own vehicle, and a monocular camera (22) for capturing a predetermined second area in the traveling direction of the own vehicle;
a processor (10) configured to execute a distance acquisition processing to acquire a first distance (ΔL1) between a stationary object located in the traveling direction of the own vehicle and the own vehicle, based on the distance acquired by the distance measuring sensor, and to acquire a second distance (ΔL2) between the own vehicle and a moving object moving toward the own vehicle based on an image (IMG) captured by the monocular camera;
the processor further configured to execute a first warning processing to control a warning device (30) so that a predetermined first warning is issued when a first condition concerning the first distance is satisfied, and to execute a second warning processing to control the warning device so that a predetermined second warning is issued when a second condition concerning the second distance is satisfied.

The processor, when both the first condition and the second condition are satisfied, acquires the second distance based on the position (Yc) of the moving object in the vertical direction within the imaging range of the monocular camera, and if the second distance is larger than the first distance and the difference (ΔL) exceeds a threshold (ΔLth), controls the priority of the second warning processing over the first warning processing, based on a feature amount (α=ΔYc/ΔYs) which is the amount of change in the position (Yc) of the image of the moving object relative to the amount of change in the size (Ys) of the image of the moving object when the image moves downward and expands within the imaging range of the monocular camera.

The processor of the vehicle control device according to the present invention acquires the second distance based on the position of the image of the moving object within the imaging range of the monocular camera. However, as described above, the accuracy of the second distance obtained based solely on the position of the image of the moving object may be low. For example, even if the second distance (the distance between the own vehicle and the moving object) is estimated to be relatively large compared to the first distance (the distance between the own vehicle and a stationary object), in reality, the difference between the first and second distances may be minimal.

Here, when the moving object is captured by the monocular camera from its front side in a scene where the moving object is moving toward the own vehicle, the image of the moving object (e.g., the lower edge of the image) moves downward and enlarges within the imaging range of the monocular camera. In a scene where the moving object is descending stairs or a slope and moving toward the own vehicle, the larger the vertical movement of the moving object, the larger the feature amount (the amount of change in the position of the image relative to the amount of change in the size of the image). Therefore, in the present invention, if the feature amount exceeds a predetermined value, the second distance (the distance estimated based only on the position of the image of the moving object) is considered to be inaccurate, and the processor increases the priority of the second warning processing. This prioritization enhances the safety of the moving object by giving precedence to the alert for the moving object.

In the vehicle control device according to one embodiment of the present invention,
the predetermined value is the amount of change in the position of the image of the moving object relative to the amount of change in the size of the image of the moving object when the moving object moves toward the own vehicle in parallel to the optical axis (ax) of the monocular camera.

According to this, when the moving object moves toward the own vehicle while descending in an inclined direction relative to the optical axis of the monocular camera, the priority of the second warning processing is increased.

In another embodiment of the vehicle control device according to the present invention,
the stationary object is a staircase, and
the moving object is a pedestrian descending the staircase.

According to this, when the pedestrian is descending the staircase and moving toward the own vehicle, the priority of the second warning processing (the priority of alerting the pedestrian) is increased.

In another embodiment of the vehicle control device according to the present invention,
the first condition is satisfied when the first distance is equal to or less than a first threshold,
the second condition is satisfied when the second distance is equal to or less than a second threshold, and
the processor is configured to temporarily change the first and second thresholds so that only the second condition is satisfied when the feature amount exceeds the predetermined value.

According to this, when the feature amount exceeds the predetermined value, the first and second thresholds are temporarily changed so that only the second condition is satisfied. For example, the first threshold is set to an extremely small value, and the second threshold is set to an extremely large value. This increases the priority of the second warning processing.

In another embodiment of the vehicle control device according to the present invention,
the stationary object is an obstacle that restricts the movement of the moving object toward the own vehicle, and
the processor is configured to execute the second warning processing when the obstacle is absent and the second condition is satisfied.

According to this, the processor recognizes only the obstacle (e.g., wall or fence) as a stationary object and considers other stationary objects as non-existent, even if they are present. In other words, the processor acquires the first distance, which is the distance between the obstacle and the own vehicle, but does not acquire the distance between other stationary objects and the own vehicle. If there is no obstacle and a moving object is present, the processor executes the second warning processing when the second warning condition concerning the distance between the moving object and the own vehicle is satisfied. This enhances the safety of the moving object.

### BRIEF DESCRIPTION OF THE DRAWINGS

FIG. 1 is a block diagram of a vehicle control device according to one embodiment of the present invention.

FIG. 2 is a side view showing a scene where a pedestrian is descending stairs and moving toward the own vehicle, and an example of an image captured in the same scene.

FIG. 3 is a side view showing a scene where a pedestrian is moving toward the own vehicle in parallel to the optical axis of the camera, and an example of an image captured by the camera in the same scene.

FIG. 4 is a flowchart of a program executed by the CPU to realize the warning function.

### DESCRIPTION OF THE EMBODIMENTS

### Overview

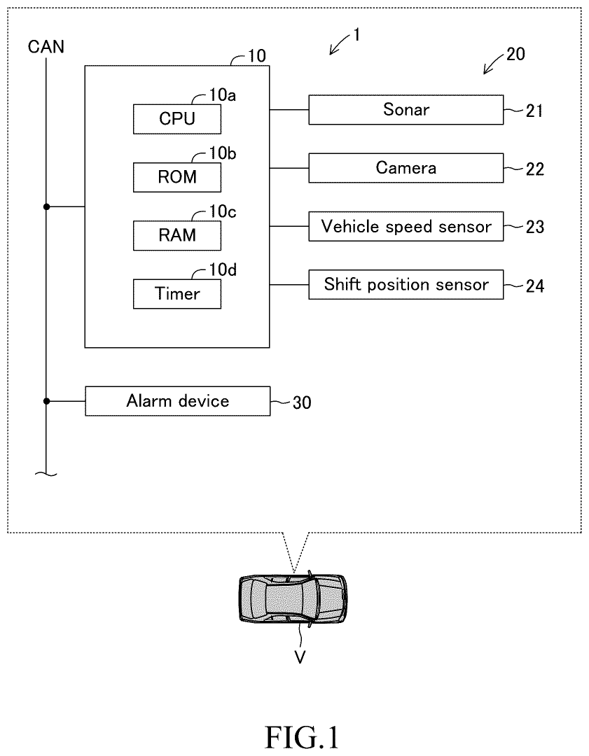

As shown in FIG. 1, a vehicle control device 1 according to one embodiment of the present invention is applied to a vehicle V (hereinafter referred to as “the own vehicle”) equipped with an autonomous driving function. The vehicle control device 1 has a warning function that issues an alert to the driver of the own vehicle when the distance between the own vehicle and an object located around it falls below a threshold, in a state where the autonomous driving function is disabled.

### (Specific Configuration)

As shown in FIG. 1, the vehicle control device 1 includes an ECU 10, a surrounding sensor 20, and a warning device 30.

The ECU 10 is a microcomputer that includes a CPU 10a, a ROM 10b (rewritable non-volatile memory), a RAM 10c, a timer 10d, and other components. The CPU realizes various functions by executing programs (instructions) stored in the ROM. The ECU 10 is connected to other ECUs via a CAN (Controller Area Network).

The surrounding sensor 20 includes a sonar 21, which is a sensor for measuring the distance between the own vehicle and objects located around it, and a camera 22 for capturing the surrounding area of the own vehicle.

The sonar 21 intermittently emits ultrasonic waves to the right-rear and left-rear of the own vehicle and receives ultrasonic waves (reflected waves) reflected by three-dimensional objects. The sonar 21 calculates the distance between the own vehicle and the three-dimensional object based on the time from when the ultrasonic wave is transmitted until the reflected wave is received, and provides the calculated result to the ECU 10.

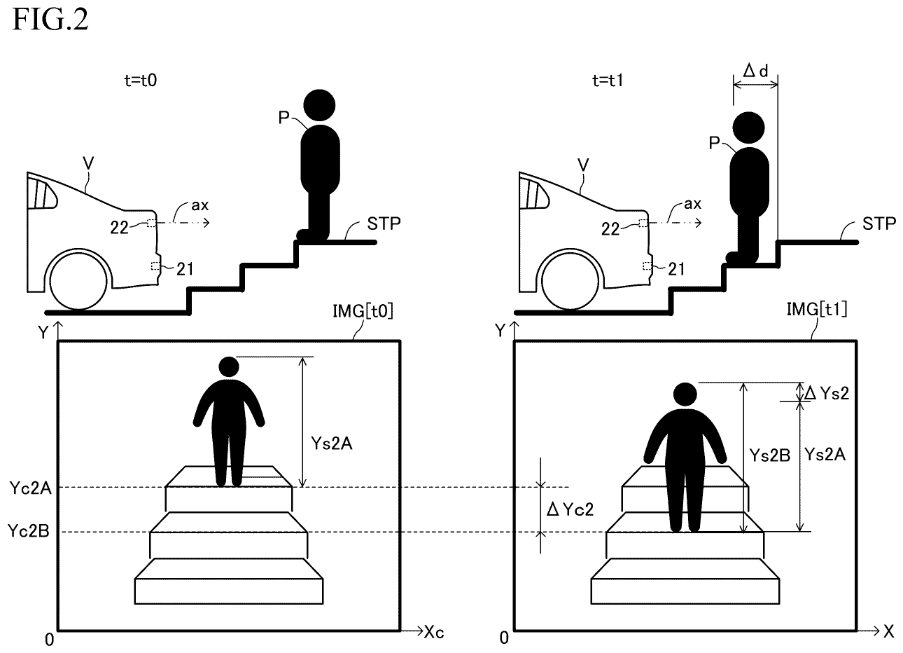

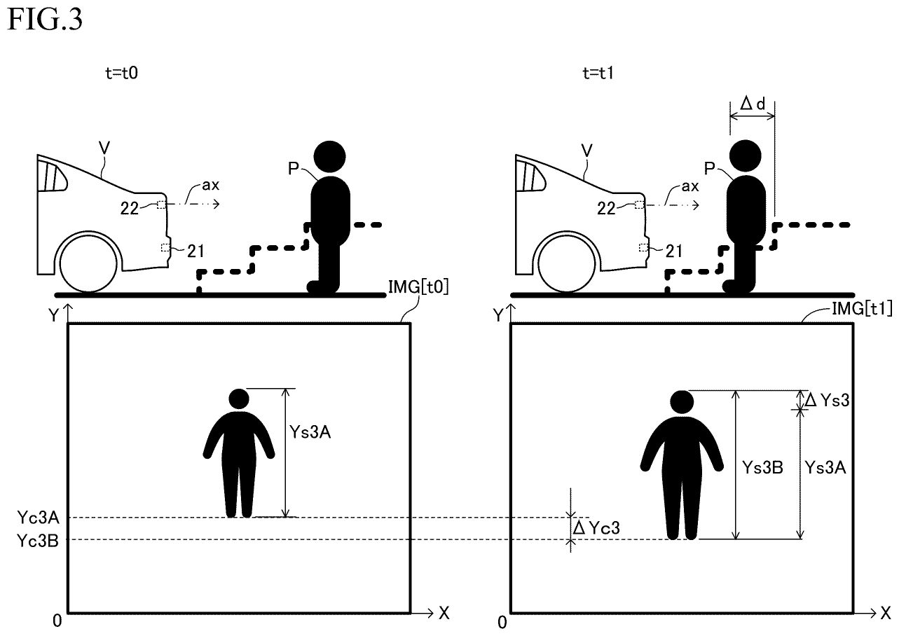

The camera 22 includes an imaging device and an image analysis device. The imaging device is, for example, a monocular camera with a built-in CCD. The imaging device is installed at the rear of the own vehicle and directed toward the rear. It captures the rear area of the own vehicle at a predetermined frame rate to obtain image data. The image analysis device analyzes the image data obtained from the imaging device and recognizes (identifies) objects around the own vehicle from the image (IMG). For example, the image analysis device can recognize a pedestrian (P). Specifically, the image analysis device distinguishes the region occupied by the pedestrian (P) from other regions in the obtained image (IMG). As shown in FIG. 2 and FIG. 3, the image analysis device acquires the vertical coordinate (Yc) of the pedestrian's feet (a feature point) in the vertical direction (Y-axis) within the image (IMG) and the vertical size (Ys) in the vertical direction (the number of pixels), and provides this information representing the vertical coordinate (Yc) and vertical size (Ys) to the ECU 10. Additionally, the image analysis device recognizes walls, fences, and other objects captured in the image (IMG), and provides the recognition results to the ECU 10.

Furthermore, the surrounding sensor 20 includes a vehicle speed sensor 23 for acquiring the speed of the own vehicle. The vehicle speed sensor 23 includes a rotational speed measurement circuit and a vehicle speed calculation device. The rotational speed measurement circuit includes a pulse generation circuit that outputs pulses (electrical signals) each time the vehicle's wheels rotate by a predetermined angle, and a counter circuit that counts the number of pulses. The vehicle speed calculation device acquires the output value (number of pulses) from the counter circuit at a predetermined cycle (each unit time), and resets the count value to “0.” In this way, the vehicle speed calculation device acquires the rotational speed (N) of the wheels per unit time. The vehicle speed calculation device multiplies the rotational speed (N) by a coefficient (k) to obtain the vehicle speed (vs, absolute value). The vehicle speed calculation device provides information representing the acquired vehicle speed (vs) to the ECU 10.

Furthermore, the surrounding sensor 20 includes a shift position sensor 24 for acquiring the current position of the shift lever (forward position, reverse position, etc.) of the own vehicle. The shift position sensor 24 provides the information representing the acquired current shift position to the ECU 10.

The warning device 30 includes a display device and an audio device. The display device displays images based on the image display command obtained from the ECU 10. The audio device plays audio based on the voice playback command obtained from the ECU 10.

### (Warning Function)

The ECU 10 sequentially acquires information representing the shift position from the shift position sensor 24. When the current shift position is in the reverse position, the ECU 10 sequentially acquires the distance between the own vehicle and a three-dimensional object from the sonar 21. Additionally, the ECU 10 sequentially acquires the vehicle speed (vs) of the own vehicle from the vehicle speed sensor 23. Based on this information, the ECU 10 acquires the distance (ΔL1) between a stationary object located behind the own vehicle and the own vehicle. When the distance (ΔL1) is equal to or less than a threshold (ΔL1th), the ECU 10 determines that the first warning condition is met.

Additionally, when the current shift position is in the reverse position, the ECU 10 sequentially acquires the vertical coordinate (Yc, the position of the pedestrian's feet in the image IMG) from the camera 22. Based on the vertical coordinate (Yc), the ECU 10 estimates the distance (ΔL2) between the own vehicle and the pedestrian (P) (the distance in the direction parallel to the optical axis of the camera 22). Specifically, the ROM 10b stores a map (MP, database) defining the relationship between the vertical coordinate (Yc) and the distance (ΔL2), and the ECU 10 refers to this map (MP) to acquire the distance (ΔL2, current value). When the distance (ΔL2) is decreasing (i.e., when the pedestrian (P) is moving toward the own vehicle) and the distance (ΔL2) is equal to or less than a threshold (ΔL2th), the ECU 10 determines that the second warning condition is met.

In the map (MP), the distance (ΔL2a) corresponding to the vertical coordinate (Yca) is greater than the distance (ΔL2b) corresponding to the lower vertical coordinate (Ycb<Yca). In other words, the distance between the pedestrian (P) and the own vehicle is estimated to be greater when the pedestrian (P) is captured in the upper part of the image (IMG) than when the pedestrian (P) is captured in the lower part of the same image (IMG).

When the first warning condition is satisfied and the second warning condition is not satisfied, the ECU 10 controls the warning device 30 to issue a predetermined first warning to alert the driver to the stationary object behind the own vehicle (first warning processing). Specifically, the ECU 10 causes the warning device 30 to display a predetermined first image and play a predetermined first sound.

When the first warning condition is not satisfied and the second warning condition is satisfied, the ECU 10 controls the warning device 30 to issue a predetermined second warning to alert the driver to the pedestrian (P) behind the own vehicle (second warning processing). Specifically, the ECU 10 causes the warning device 30 to display a predetermined second image and play a predetermined second sound.

When both the first warning condition and the second warning condition are satisfied, the ECU 10 controls the warning device 30 to issue either the first warning or the second warning, as described below. That is, when the ECU 10 determines that the driver should prioritize attention to the stationary object, it controls the warning device 30 to issue the first warning. On the other hand, when the ECU 10 determines that the driver should prioritize attention to the pedestrian (P), it controls the warning device 30 to issue the second warning.

Specifically, the ECU 10 determines whether the following condition X regarding the relative magnitudes of distance ΔL1 and distance ΔL2 is satisfied.

(Condition X): The difference ΔL=(=ΔL2−ΔL1) between distance ΔL1 and distance ΔL2 exceeds the threshold ΔLth.

Condition X is not satisfied when “the pedestrian (P) is estimated to be closer to the own vehicle than the stationary object,” or “the pedestrian (P) is estimated to be farther from the own vehicle than the stationary object, but the pedestrian (P) and the stationary object are estimated to be relatively close to each other.” In such cases, it is preferable to prioritize alerting for the potential contact between the own vehicle and the pedestrian (P). Therefore, when condition X is not satisfied, the ECU 10 controls the warning device 30 to issue the second warning.

On the other hand, condition X is satisfied when the pedestrian (P) is estimated to be significantly farther from the own vehicle than the stationary object. Here, distance ΔL2 is a value obtained (estimated) based solely on the vertical coordinate Yc (the coordinate of the pedestrian's feet in the vertical direction within the imaging range of the monocular camera) of the pedestrian (P) captured in the image (IMG). As described above, the accuracy of distance ΔL2 obtained by this method is low. Therefore, even if condition X is satisfied (i.e., the pedestrian (P) is estimated to be significantly farther from the own vehicle than the stationary object), in reality, the stationary object and the pedestrian (P) may be in close proximity. This kind of misdetection can occur, for example, when the pedestrian (P) is at a relatively higher position than the own vehicle (camera 22), as shown in FIG. 2.

FIG. 2 shows a scene where the pedestrian (P) is descending the stairs (STP) and approaching the own vehicle. In this example, as shown in FIG. 2(A), at time t0 when the pedestrian (P) is positioned at the top of the stairs (STP), the pedestrian (P) is captured in the upper part of the image IMG[t0]. Therefore, compared to distance ΔL1 (the distance between the own vehicle and the stairs (STP) obtained by the sonar 21), distance ΔL2 (the distance obtained based on the vertical coordinate Yc) is significantly larger, and condition X is satisfied (ΔL2−ΔL1>ΔLth). In other words, in this example, the pedestrian (P) is erroneously estimated (misdetected) to be significantly farther from the own vehicle than the stairs (STP).

The ECU 10 determines whether such misdetection has occurred as follows. Specifically, when condition X is satisfied, the ECU 10 sequentially acquires the vertical coordinate (Yc) and the vertical size (Ys) from the camera 22. Based on the amount of change in the vertical coordinate (Yc) relative to the amount of change in the vertical size (Ys) (i.e., the amount of change in the estimated distance ΔL2), the ECU 10 determines whether the pedestrian (P) is descending the stairs (STP) or a slope while moving toward the own vehicle. This determination process is specifically explained below with reference to FIG. 2 and FIG. 3. In the examples shown in FIG. 2 and FIG. 3, the own vehicle is temporarily stopped.

As shown in FIG. 2, during the transition from time to, when the pedestrian (P) is positioned at the top step of the stairs (STP), to time t1, when the pedestrian moves to the middle step (FIG. 2(B)), the pedestrian (P) moves a distance Δd in the direction parallel to the optical axis (ax) of the camera 22. The vertical coordinate (Yc2A) of the pedestrian's feet in the image (IMG[t0]) obtained at time t0 is higher than the vertical coordinate (Yc2B) of the pedestrian's feet in the image (IMG[t1]) obtained at time t1. Additionally, the vertical size (Ys2B) of the pedestrian (P) in the image (IMG[t1]) is larger than the vertical size (Ys2A) of the pedestrian (P) in the image (IMG[t0]). That is, as the pedestrian (P) descends one step of the stairs (STP), the vertical coordinate (Yc) moves downward, and the vertical size (Ys) expands within the imaging range of the camera 22.

On the other hand, FIG. 3 shows a scene where the pedestrian (P) moves toward the own vehicle in parallel to the optical axis (ax) of the camera 22. In this example, the distance the pedestrian (P) moves from time to t0 time t1 is the same as the distance Δd the pedestrian (P) moved in the scene shown in FIG. 2. The vertical coordinate (Yc3A) of the pedestrian's feet in the image (IMG[to]) is higher than the vertical coordinate (Yc3B) of the pedestrian's feet in the image (IMG[1]). Additionally, the vertical size (Ys3B) of the pedestrian (P) in the image (IMG[t1]) is larger than the vertical size (Ys3A) of the pedestrian (P) in the image (IMG[t0]). That is, as the pedestrian (P) moves forward, the vertical coordinate (Yc) moves downward, and the vertical size (Ys) expands within the imaging range of the camera 22.

Here, when the pedestrian (P) moves forward by a distance Δd while descending the stairs (STP) (FIG. 2), the amount of change in the vertical size (ΔYs2=Ys2B−Ys2A) is the same as the amount of change in the vertical size (ΔYs3=Ys3B−Ys3A) when the pedestrian (P) moves forward by a distance Δd in parallel to the optical axis of the camera 22 (FIG. 3). However, the amount of change in the vertical coordinate (ΔYc2=Yc2A−Yc2B) when the pedestrian (P) moves forward by a distance Δd while descending the stairs (STP) (FIG. 2) is greater than the amount of change in the vertical coordinate (ΔYc3=Yc3A−Yc3B) when the pedestrian (P) moves forward by a distance Δd in parallel to the optical axis of the camera 22 (FIG. 3). Thus, the amount of change in the vertical size (Ys) has a positive correlation with the distance the pedestrian (P) moves in the direction of the optical axis. In contrast, the amount of change in the vertical coordinate (Yc) not only has a positive correlation with the distance the pedestrian (P) moves in the direction of the optical axis, but also with the distance the pedestrian (P) moves in the vertical direction. Based on this insight, when the amount of change in the vertical coordinate (Yc) relative to the amount of change in the vertical size (Ys) (hereinafter referred to as “feature quantity α”) is relatively large when the image of the pedestrian (P) expands in the image (IMG) within the imaging range of the camera 22, it can be estimated that the pedestrian (P) is approaching the own vehicle while descending from a higher position than the own vehicle (camera 22).

Therefore, the ECU 10 sequentially acquires the vertical coordinate (Yc) and the vertical size (Ys) and, based on these time-series data, calculates the feature quantity a as the amount of change in the vertical coordinate (Yc) relative to the amount of change in the vertical size (Ys). The ECU 10 then determines whether the feature quantity a exceeds a threshold (αth). Here, the amount of change in the vertical coordinate (ΔYc3) relative to the amount of change in the vertical size (ΔYs3) when the pedestrian (P) moves toward the own vehicle in parallel to the optical axis (FIG. 3) is pre-measured, and the measurement result is stored in the ROM 10b as the threshold (αth).

When the feature quantity a exceeds the threshold αth, it is highly likely that the pedestrian (P) is moving toward the own vehicle while descending from a relatively high position, and the distance ΔL2 estimated based solely on the vertical coordinate Yc is likely inaccurate. In other words, the actual distance between the own vehicle and the pedestrian (P) may be smaller than the estimated distance ΔL2. Therefore, in this case (α>αth), the ECU 10 selects the pedestrian (P) as the object of the warning and controls the warning device 30 so that the second warning is issued. That is, the ECU 10 increases the priority of the second warning over the first warning. On the other hand, when the feature quantity a is equal to or less than the threshold αth, the ECU 10 selects the stationary object as the object of the warning and controls the warning device 30 so that the first warning is issued.

When the own vehicle is reversing, the ECU 10, in calculating the feature quantity α, subtracts the correction amounts ΔYc[vs] and ΔYs[vs] corresponding to the vehicle speed vs from the changes in the vertical coordinate ΔYc and the vertical size ΔYs, respectively. A map representing the relationship between the vehicle speed vs and the correction amounts is predesigned and stored in the ROM 10b.

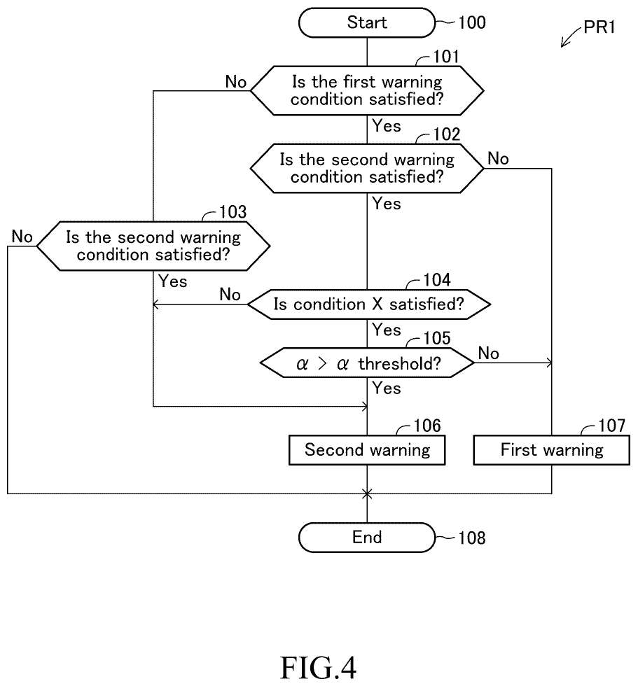

Next, referring to FIG. 4, the program PR1 executed by the CPU 10a (hereinafter simply referred to as “CPU”) of the ECU 10 to realize the above-described warning function will be explained.

When the ignition switch is in the ON state, the CPU sequentially acquires the current shift position from the shift position sensor 24. When the current shift position is the reverse position, the CPU starts executing the program PR1 at a predetermined cycle. The CPU starts executing program PR1 from step 100 and proceeds to step 101.

In step 101, the CPU determines whether the first warning condition is satisfied. If the CPU determines that the first warning condition is satisfied (ΔL1≤ΔL1th) (101: Yes), it proceeds to step 102. On the other hand, if the CPU determines that the first warning condition is not satisfied (101: No), it proceeds to step 103.

In step 102, the CPU determines whether the second warning condition is satisfied. If the CPU determines that the second warning condition is satisfied (ΔL2≤ΔL2th) (102: Yes), it proceeds to step 104. On the other hand, if the CPU determines that the second warning condition is not satisfied (102: No), it proceeds to step 107.

In step 103, the CPU determines whether the second warning condition is satisfied. If the CPU determines that the second warning condition is satisfied (ΔL2≤ΔL2th) (103: Yes), it proceeds to step 106. On the other hand, if the CPU determines that the second warning condition is not satisfied (103: No), it proceeds to step 108, where program PR1 execution ends.

In step 104, the CPU determines whether condition X is satisfied. If the CPU determines that condition X is satisfied (ΔL2-ΔL1>ΔLth) (104: Yes), it proceeds to step 105. On the other hand, if the CPU determines that condition X is not satisfied (104: No), it proceeds to step 106.

In step 105, the CPU calculates the feature quantity a and determines whether the feature quantity a exceeds the threshold αth. If the CPU determines that the feature quantity a exceeds the threshold αth (105: Yes), it proceeds to step 106. On the other hand, if the CPU determines that the feature quantity a does not exceed the threshold αth (105: No), it proceeds to step 107.

In step 106, the CPU controls the warning device 30 so that the first warning is issued. Then, the CPU proceeds to step 108, where it terminates the execution of program PR1.

In step 107, the CPU controls the warning device 30 so that the second warning is issued. Then, in step 108, the CPU proceeds to terminate the execution of program PR1.

### Effect

The ECU 10 of the vehicle control device 1 acquires the distance ΔL2 based on the position (vertical coordinate Yc) of the image of the pedestrian (P) within the imaging range of the camera 22. However, as mentioned above, the accuracy of the distance ΔL2 obtained by this method is low. Therefore, there are cases where the distance ΔL2 (the distance between the own vehicle and the pedestrian descending the stairs STP, estimated based on the vertical coordinate Yc) is erroneously estimated to be relatively large compared to the distance ΔL1 (the distance between the own vehicle and the stairs STP, obtained by the sonar 21).

Here, when the pedestrian (P) is captured by the camera 22 from the front side in a scene where the pedestrian is moving toward the own vehicle, the image of the pedestrian (P) (the position of the feet) moves downward and expands within the imaging range of the camera 22. In the scene where the pedestrian (P) is moving toward the own vehicle while descending the stairs STP (or a slope) (FIG. 2), the greater the vertical movement, the larger the feature quantity a (the amount of change ΔYc in the vertical coordinate Yc relative to the amount of change ΔYs in the vertical size Ys). Therefore, in this embodiment, if the feature quantity a exceeds the threshold αth, the ECU 10 considers the distance ΔL2 (the distance between the own vehicle and the pedestrian (P) estimated based solely on the vertical coordinate Yc) to be inaccurate, and increases the priority of the second warning. This prioritization enhances the attention given to the pedestrian (P), thereby improving the pedestrian's safety.

The present invention is not limited to the above embodiments, and various modifications can be made within the scope of the present invention.

### <Modification 1>

When both the first and second warning conditions are satisfied and the feature quantity a exceeds the threshold αth, the ECU 10 temporarily changes the thresholds ΔL1th and ΔL2th so that only the second warning condition is satisfied. For example, the ECU 10 sets the threshold ΔL1th to an extremely small value and the threshold ΔL2th to an extremely large value. The ECU 10 then restores the thresholds ΔL1th and ΔL2th to their original (standard) values when the pedestrian (P) is no longer recognized (i.e., when the pedestrian (P) moves out of the imaging range of the camera 22).

### <Modification 2>

When no stationary object, such as a low wall or fence that restricts the approach of the pedestrian (P) to the own vehicle, is present in the direction of the own vehicle's movement (in the case of FIG. 2, behind the vehicle), and both stationary objects other than the obstacle and the pedestrian (P) are detected, the second warning may be prioritized regardless of the distances ΔL1 and ΔL2. This further enhances the safety of the pedestrian (P). On the other hand, when an obstacle is present in the direction of the own vehicle's movement, the ECU 10 determines whether the pedestrian (P) is present on the side of the obstacle closer to the own vehicle, following the same procedure as in the above embodiment. In this modification, the stationary object is limited to an obstacle. The ECU 10 can determine the presence or absence of the obstacle based on information obtained from the camera 22. Additionally, when the ECU 10 detects a continuous stationary object or regularly spaced stationary objects behind the own vehicle, whose width is larger than the width of the own vehicle and whose height is almost constant, based on information obtained from the sonar 21, it may recognize such stationary objects as obstacles.

### OTHER

The ECU 10 may calculate the feature quantity a regardless of the status of the first and second warning conditions, and control the warning device 30 to prioritize the issuance of the second warning when the feature quantity a exceeds the threshold αth.

What is claimed is:

1. A vehicle control device comprising:
a distance measuring sensor that acquires a distance between an object located in a predetermined first area in the traveling direction of an own vehicle and the own vehicle, and a surrounding sensor that includes a monocular camera that captures a predetermined second area in the traveling direction of the own vehicle;
a processor configured to execute a distance acquisition processing to acquire a first distance between a stationary object located in the traveling direction of the own vehicle and the own vehicle, based on the distance acquired by the distance measuring sensor, and to acquire a second distance between the own vehicle and a moving object moving toward the own vehicle, based on an image acquired by the monocular camera;
the processor further configured to execute a first warning processing to control a warning device so that a predetermined first warning is issued when a first condition concerning the first distance is satisfied, and to execute a second warning processing to control the warning device so that a predetermined second warning is issued when a second condition concerning the second distance is satisfied;
wherein the processor, when the first condition and the second condition are both satisfied, acquires the second distance based on the position of the moving object in the vertical direction of the imaging range of the monocular camera, and if the second distance is larger than the first distance and the difference exceeds a threshold, controls the priority of the second warning processing over the first warning processing, based on a feature amount that is the amount of change in the position of the image of the moving object in relation to the amount of change in the size of the image of the moving object when the image of the moving object moves downward and expands within the imaging range of the monocular camera.

2. The vehicle control device according to claim 1,
wherein the predetermined value is the amount of change in the position of the image of the moving object in relation to the amount of change in the size of the image of the moving object when the moving object moves toward the own vehicle in parallel to the optical axis of the monocular camera.

3. The vehicle control device according to claim 1,
wherein the stationary object is a staircase, and the moving object is a pedestrian descending the staircase.

4. The vehicle control device according to claim 1,
wherein the first condition is satisfied when the first distance is equal to or less than a first threshold,
the second condition is satisfied when the second distance is equal to or less than a second threshold, and
the processor is configured to temporarily change the first threshold and the second threshold so that only the second condition is satisfied when the feature amount exceeds the predetermined value.

5. The vehicle control device according to claim 1,
wherein the stationary object is an obstacle that restricts the movement of the moving object toward the own vehicle, and
the processor is configured to execute the second warning processing when the obstacle is absent and the second condition is satisfied.
